(19) United States
(12) Patent Application Publication
(10) Pub. No.: US 2009/0027487 A1
(43) Pub. Date: Jan. 29, 2009

(54) IMAGE DISPLAY APPARATUS AND IMAGE DISPLAY METHOD

(76) Inventor: Takeshi MISAWA, Kurokawa-gun (JP)

Correspondence Address: BIRCH STEWART KOLASCH & BIRCH, PO BOX 747, FALLS CHURCH, VA, 22040-0747, US

(21) Appl. No.: 12/138,255

(22) Filed: Jun. 12, 2008

(30) Foreign Application Priority Data
Jun. 15, 2007 (JP) 2007-159431

(51) Int. Cl. H04N 13/04

(52) U.S. Cl. 348/51; 348/E13.075

(57) ABSTRACT

An image display apparatus according to an aspect of the present invention includes an image obtaining device which obtains image data taken from multiple viewpoints, an image processing device which selects one of the image data and applies a process of emphasizing a stereoscopic effect with respect to the selected image data, to generate list display image data, a file generation device which generates a recorded image file which stores the list display image data and the image data taken from the multiple viewpoints, and a display device which, when the recorded image file is displayed in a list, uses the list display image data to perform the list display.

### BACKGROUND OF THE INVENTION

1. Field of the Invention

The present invention relates to an image display apparatus and an image display method, and more particularly, to an image display apparatus and an image display method which use image data from multiple viewpoints to generate an image for three-dimensional display.

2. Description of the Related Art

Japanese Patent Application Laid-Open No. 2004-102513 discloses an image processing apparatus which applies correction of luminance, color difference, vertical position or the like to an obtained parallax image and generates an image for stereoscopic viewing.

Japanese Patent Application Laid-Open No. 2004-274091 (FIG. 9) discloses that, in an image data generation apparatus which generates image data from an image from multiple viewpoints, a file header of the image from the multiple viewpoints and image information are integrated into a file of a known format as a single unit.

Japanese Patent Application Laid-Open No. 2004-120165 discloses, in the case where thumbnail display is performed in a 2D mode an example of venerating a thumbnail image from image data for the left eye and image data for the right eye (FIG. 6 (a)) and an example of generating the thumbnail image from the image data for the left eye and adding a sign of “2D” or “3D” (FIG. 6(d)).

### SUMMARY OF THE INVENTION

The inventor of the present invention studied such conventional technique and has found a problem in it.

An image display apparatus capable of performing three-dimensional display is not always used for the three-dimensional display, but is also used for recording and displaying an image for two-dimensional display. If images are displayed in a list in the image display apparatus capable of performing the three-dimensional display, it is necessary to perform the display so that the image for the two-dimensional display and an image for the three-dimensional display can be distinguished. As a means which displays the image for the two-dimensional display and the image for the three-dimensional display in a distinguishable manner, for example, it is conceivable to attach characters such as “2D” to the image for the two-dimensional display, and to attach characters such as “3D” or “left (leave an image on the left eye side)” to the image for the three-dimensional display. However, when many images are stored and the number (density) of images to be displayed on one screen becomes larger, the display with the characters has a problem of not being intelligible.

Moreover, as another means which displays the image for the two-dimensional display and the image for the three-dimensional display in a distinguishable manner, for example, it is also conceivable to display the image on the left eye side and an image on the right eye side, side by side, with respect to the image for the three-dimensional display. However, the images displayed in the list become significantly different from actual three-dimensional display, which causes a problem of bringing significant discomfort to a user.

The present invention has been made in view of the above described circumstances, and it is an object of the present invention to provide an image display apparatus and an image display method in which if an image for two-dimensional display and an image for three-dimensional display are displayed in a list, both the image for the two-dimensional display and the image for the three-dimensional display can be easily distinguished without discomfort.

In order to solve the above described problems, an image display apparatus according to a first aspect of the present invention comprises an image obtaining device which obtains image data taken from multiple viewpoints, an image processing device which selects one of the image data and applies a process of emphasizing a stereoscopic effect with respect to the selected image data to generate list display image data, a file generation device which generates a recorded image file which stores the list display image data and the image data taken from the multiple viewpoints, and a display device which, when the recorded image file is displayed in a list, uses the list display image data to perform the list display.

According to the first aspect, when the images are displayed in the list, it is possible to perform the list display in which an image file for the two-dimensional display and an image file for the three-dimensional display can be intuitively distinguished with less discomfort, by displaying the list display image data in which the stereoscopic effect has been emphasized, with respect to the image file for the three-dimensional display.

A second aspect of the present invention provides the image display apparatus of the first aspect, wherein the image processing device applies a process of reducing an amount of visual information of a background area with respect to the selected image data to generate the list display image data.

According to the second aspect, when the images are displayed in the list, it is possible to perform the list display in which the image for the two-dimensional display and the image for the three-dimensional display can be intuitively distinguished with less discomfort, by reducing an amount of visual information of the background area to emphasize the stereoscopic effect, with respect to the image for the three-dimensional display.

A third aspect of the present invention provides the image display apparatus of the second aspect, wherein the image processing device applies at least one process of a process of deleting an image in the background area, a process of blurring the background area, a process of desaturating the background area, and a process of the list display image data.

A fourth aspect of the present invention provides the image display apparatus of the first to third aspects, wherein the image processing device selects image data taken by an image taking device in which the viewpoint is located adjacent to a middle, from the image data taken from the multiple viewpoints.

As shown in the fourth aspect, it is possible to perform the display with further less discomfort, by selecting the image data for generating the list display image data.

An image display method according to a fifth aspect of the present invention comprises an image obtaining step of obtaining image data taken from multiple viewpoints, an image processing step of selecting one of the image data and applying a process of emphasizing a stereoscopic effect with respect to the selected image data to generate list display image data, a file generation step of generating a recorded image file which stores the list display image data and the image data taken from the multiple viewpoints, and a display step of, when the recorded image file is displayed in a list, using the list display image data to perform the list display.

A sixth aspect of the present invention provides the image display method of the fifth aspect, wherein in the image processing step, a process of reducing a visual information amount of a background area is applied with respect to the selected image data, and the list display image data is generated.

A seventh aspect of the present invention provides the image display method of the sixth aspect, wherein in the image processing step, at least one process of a process of deleting an image in the background area, a process of blurring the background area, a process of desaturating the background area, and a process of reducing tone in the background area is applied with respect to the selected image data, and the list display image data is generated.

According to the present invention, when the images are displayed in the list, it is possible to perform the list display in which the image for the two-dimensional display and the image for the three-dimensional display can be intuitively distinguished with less discomfort, by emphasizing the stereoscopic effect (for example, blurring the background area) and performing the display with respect to the image for the three-dimensional display.

### BRIEF DESCRIPTION OF THE DRAWINGS

FIG. 1 is a block diagram showing a main configuration of an image taking apparatus provided with an image display apparatus according to a first embodiment of the present invention;

FIG. 2 is a diagram schematically showing a data structure of an enhanced image file F100;

FIG. 3 is a diagram showing a processing flow in an image file generation unit 70 when list display image data P_{R} is generated;

FIG. 4 is a diagram showing an example of list display of images;

FIG. 5 is a block diagram showing a main configuration of an image processing apparatus according to a second embodiment of the present invention; and

### DETAILED DESCRIPTION OF THE PREFERRED EMBODIMENTS

Preferred embodiments of an image display apparatus and an image display method according to the present invention will be described below according to the accompanying drawings.

### First Embodiment

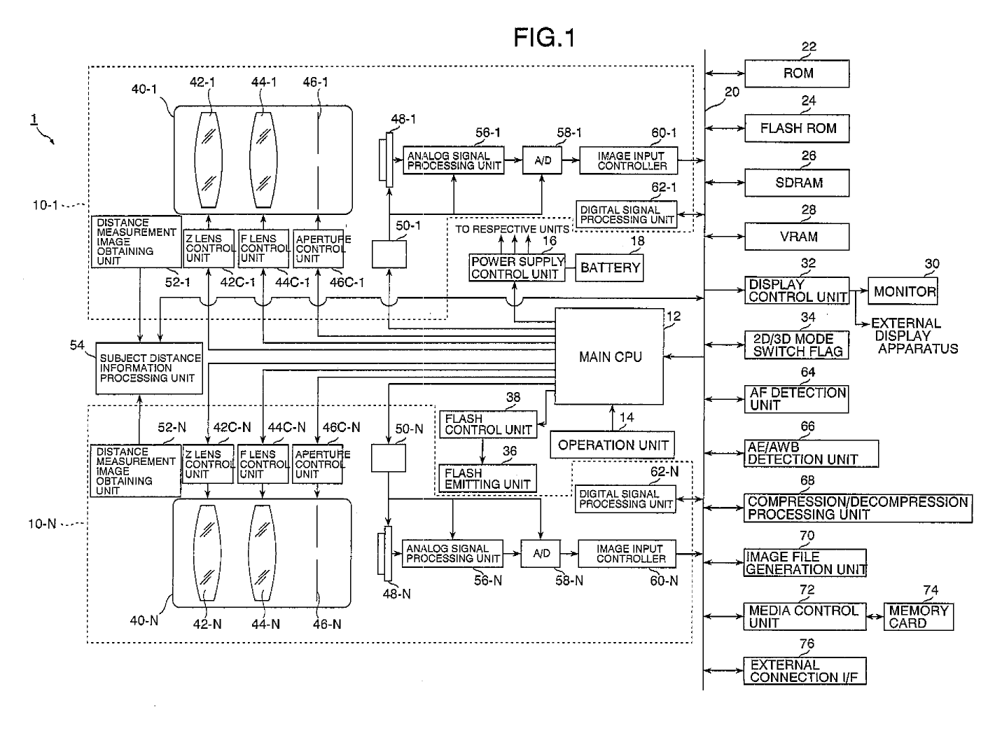

FIG. 1 is a block diagram showing a main configuration of an image taking apparatus provided with an image display apparatus according to a first embodiment of the present invention. As shown in FIG. 1, an image taking apparatus 1 is provided with multiple image taking units 10-1, 10-2, . . . , 10-N (N≧2), and is an apparatus which obtains a parallax image of the same subject taken from multiple viewpoints and records the parallax image as a recorded image file of a predetermined format.

A main CPU 12 (hereinafter referred to as “CPU 12”) functions as a control device which generally controls operations of the entire image taking apparatus 1 based on input from an operation unit 14, according to a predetermined control program. A power supply control unit 16 controls electric power from a battery 18 and supplies operating power to respective units in the image taking apparatus 1.

A ROM 22, a flash ROM 24, an SDRAM 26 and a VRAM 28 are connected to the CPU 12 via a bus 20. The control program executed by the CPU 12, various data required for the control and the like are stored in the ROM 22. Various setting information and the like related to the operations of the image taking apparatus 1, such as user setting information, are stored in the flash ROM 24.

The SDRAM 26 includes an operation work area for the CPU 12 and a temporary storage area (work memory) for image data. The VRAM 28 includes a temporary storage area dedicated to display image data.

A monitor 30 is configured with, for example, a display device provided with a color liquid crystal panel, used as an image display unit for displaying taken images, and also used as a GUI at the time of various settings. Moreover, the monitor 30 is used as an electronic viewfinder for checking an angle of view at the time of an image taking mode.

The image taking apparatus 1 has a 2D play mode for displaying a two-dimensional image (2D image) and a 3D play mode for displaying a three-dimensional image (3D image), on the monitor 30. Here, as a device which performs three-dimensional display, for example, an anaglyph method, a color anaglyph method, a polarizing filter method and a time division stereoscopic television system which use special glasses, and in addition, for example, a parallax barrier method which forms a slit in a vertical direction on a front face of the monitor 30 and alternately arranges and displays strip-shaped image pieces showing left and right images on a display surface of the monitor 30 at the rear of the slit, a lenticular method which arranges a so-called lenticular lens having a hog-backed lens group on a surface of the monitor 30, an integral photography method using a microlens array sheet, and a holography method using an interference phenomenon are applicable. It should be noted that the device which performs the three-dimensional display is not limited to the above listing.

A display control unit 32 converts the image data read from an image pickup element 48 or a memory card 74 into a display image signal (for example, an NTSC signal, a PAL signal or an SECAM signal) and outputs the display image signal to the monitor 30, and also outputs predetermined characters and graphics information (for example, on-screen display data) to the monitor 30. Moreover, the display control unit 32 can output images to an external display apparatus connected thereto via a predetermined interface (for example, USB, IEEE 1394 or a LAN).

The operation unit 14 includes operation input devices such as a shutter button, a power supply/mode switch, a mode dial, a cross button, a zoom button, a MENU/OK button, a DISP button and a BACK button.

The power supply/mode switch functions as a switching device which switches ON/OFF of a power supply of the image taking apparatus 1 and switches an operation mode (a play mode (the 2D play mode and the 3D play mode) and the image taking mode) of the image taking apparatus 1.

The mode dial is an operation device which switches the image taking mode of the image taking apparatus 1, and depending on a set position of the mode dial, the image taking mode is switched among a 2D still image taking mode for taking a two-dimensional still image, a 2D moving image taking mode for taking a two-dimensional moving image, a 3D still image taking mode for taking a three-dimensional still image, and a 3D moving image taking mode for taking a three-dimensional moving image. If the image taking mode is set to the 2D still image taking mode or the 2D moving image taking mode, a flag showing that the image taking mode is a 2D mode for taking the two-dimensional image is set to a 2D/3D mode switch flag 34. Moreover, if the image taking mode is set to the 3D still image taking mode or the 3D moving image taking mode, a flag showing that the image taking mode is a 3D mode for taking the three-dimensional image is set to the 2D/3D mode switch flag 34. The CPU 12 determines whether the image taking mode is the 2D mode or the 3D mode, with reference to the 2D/3D mode switch flag 34.

The shutter button is configured with a switch of a two-stage stroke type consisting of so-called “half-pressing” and “full-pressing”. At the time of the still image taking mode, when the shutter button is half-pressed, an image taking preparation process (that is, AE (Automatic Exposure), AF (Auto Focus) and AWB (Automatic White Balance)) is performed, and when the shutter button is full-pressed, image taking and recording processes are performed. Moreover, at the time of the moving image taking mode, when the shutter button is full-pressed, taking of the moving image is started, and when the shutter button is full-pressed again, the image taking is ended. The setting can also be performed so that the taking of the moving image is performed while the shutter button is full-pressed and the taking is ended when the full-pressing is released. It should be noted that a shutter button for the still image taking and a shutter button for the moving image taking may be separately provided.

The cross button is provided in a manner operable to be depressed in four directions of upward, downward, leftward and rightward, and a button of each direction is assigned with a function depending on the operation mode of the image taking apparatus 1 and the like. For example, at the time of the image taking mode, a function of switching ON/OFF of a macro function is assigned to a left button, and a function of switching a flash mode is assigned to a right button. Moreover, at the time of the image taking mode, a function of changing brightness of the monitor 30 is assigned to an up button, and a function of switching ON/OFF of a self timer is assigned to a down button. At the time of the play mode, a frame advance function is assigned to the left button, and a frame return function is assigned to the right button. Moreover, at the time of the play mode, the function of changing the brightness of the monitor 30 is assigned to the up button, and a function of deleting an image being played is assigned to the down button. Moreover, at the time of the various settings, a function of moving a cursor displayed on the monitor 30 in the direction of each button is assigned to each button.

The zoom button is an operation device which performs zooming operations of the image taking units 10-1, 10-2, . . . , 10-N, and is provided with a zoom tele button which specifies to zoom to telephoto side and a zoom wide button which specifies to zoom to wide angle.

The MENU/OK button is used for invoking a menu screen (MENU function), and also used for confirmation of selected contents, instruction for executing processes and the like (OK function), and a function to be assigned is switched depending on a setting state of the image taking apparatus 1. On the menu screen, with the MENU/OK button, all adjustable items included in the image taking apparatus 1 are set, for example, including image quality adjustment such as an exposure value, coloring, image taking sensitivity or the number of recorded pixels, self timer setting, switching of a photometric method, whether or not to use a digital zoom, or the like. The image taking apparatus 1 operates depending on conditions set on this menu screen.

The DISP button is used for inputting an instruction for switching contents displayed on the monitor 30 or the like, and the BACK button is used for inputting an instruction for canceling the input operation or the like.

A flash emitting unit 36 is configured with, for example, a discharge tube (xenon tube), and light is emitted as appropriate in the case of shooting a dark subject, at the time of shooting against light, and the like. A flash control unit 38 includes a main condenser for supplying a current for causing the flash emitting unit (discharge tube) 36 to emit the light, and according to a flash emission instruction from the CPU 12, performs charge control of the main condenser, controls a timing of discharge (light emission) of the flash emitting unit 36 and a discharge time thereof, and the like. It should be noted that another light emitting device such as an LED may be used as the flash emitting unit 36.

Next, an image taking function of the image taking apparatus 1 will be described. The image taking unit 10 is provided with a taking lens 40 (a zoom lens 42, a focus lens 44 and an aperture 46), a zoom lens control unit (Z lens control unit) 42C, a focus lens control unit (F lens control unit) 44C, an aperture control unit 46C, the image pickup element 48, a timing generator (TG) 50, an analog signal processing unit 56, an A/D converter 58, an image input controller 60 and a digital signal processing unit 62. It should be noted that, in FIG. 1, although the respective units in the respective image taking units 10-1, 10-2, . . . , 10-N are attached with reference numerals 1, 2, . . . , N and thereby distinguished from one another, since functions of the respective units are generally similar, reference numerals 1, 2, . . . , N will be omitted in the following description.

The zoom lens 42 is driven by a zoom actuator (not shown) to move back and forth along an optical axis. The CPU 12 controls a position of the zoom lens 42 to perform zooming, by controlling driving of the zoom actuator via the zoom lens control unit 42C.

The focus lens 44 is driven by a focus actuator (not shown) to move back and forth along the optical axis. The CPU 12 controls a position of the focus lens 44 to perform focusing, by controlling driving of the focus actuator via the focus lens control unit 440.

The aperture 46 is configured with, for example, an iris aperture, and driven by an aperture actuator (not shown) to operate. The CPU 12 controls an opening amount (aperture value) of the aperture 46 to control an incident light amount into the image pickup element 48, by controlling driving of the aperture actuator via the aperture control unit 46C.

The CPU 12 drives taking lenses 40-1, 40-2, . . . , 40-N in the respective image taking units in a synchronized manner. In other words, the taking lenses 40-1, 40-2, . . . , 40-N are constantly set to the same-focal length (zoom magnification) and focusing is performed so as to constantly focus on the same subject. Moreover, the aperture is adjusted to constantly have the same incident light amount (aperture value).

The image pickup element 48 is configured with, for example, a color CCD image sensor. Multiple photodiodes are arranged in a two-dimensional manner on a light receiving surface of the image pickup element (CCD image sensor) 48, and color filters are arranged in a predetermined arrangement on the respective photodiodes. An optical image of the subject imaged on the light receiving surface of the CCD by the image taking lens 40 is converted into a signal charge depending on the incident light amount by this photodiode. The signal charge stored in each photodiode is sequentially read out from the image pickup element 48 as a voltage signal (image signal) depending on the signal charge, based on a driving pulse given by the TG 50 according to the instruction from the CPU 12. The image pickup element 48 is provided with an electronic shutter function in which an exposure time (shutter speed) is controlled by controlling a charge storage time with respect to the photodiode.

It should be noted that an image pickup element other than the CCD image sensor, such as a CMOS image sensor, can also be used as the image pickup element 48.

A distance measurement image obtaining unit 52 is provided with an light emitting element (for example, a light emitting diode) for illuminating light to the subject, and an image pickup element for detecting a subject distance (image pickup element for distance measurement) for taking an image of the subject illuminated with the light by the above described light emitting element (distance measurement image). The distance measurement image obtaining unit 52 is arranged in each of the image taking units 10-1, 10-2, . . . , 10-N The distance measurement image obtained by each distance measurement image obtaining unit 52 is outputted to a subject distance information processing unit 54.

The subject distance information processing unit 54 uses the distance measurement image obtained from the distance measurement image obtaining unit 52 to calculate a distance between the subject shot by the image taking units 10-1, 10-2, . . . , 10-N and the image taking apparatus 1 (subject distance) based on a principle of so-called triangular distance measurement. The subject distance information processing unit 54 generates depth information D10 based on this subject distance and provides the depth information D10 to an image file generation unit 70.

It should be noted that, as a method of calculating the subject distance, a TOF (Time of Flight) method may be used, which calculates the subject distance from a time of flight (delay time) of the light and a speed of the light, from when the light illuminated from the light emitting element is reflected by the subject until when the light reaches the image pickup element for distance measurement.

The analog signal processing unit 56 includes a correlated double sampling circuit (CDS) which removes reset noise (low frequency) included in the image signal outputted from the image pickup element 48, and an AGS circuit which amplifies the image signal to control the size of the image signal to a certain level, and performs a correlated double sampling process with respect to the image signal outputted from the image pickup element 48 and also amplifies the image signal.

The A/D converter 58 converts an analog image signal outputted from the analog signal processing unit 56 into a digital image signal.

The image input controller 60 captures the image signal outputted from the A/D converter 58 and stores the image signal in the SDRAM 26.

The digital signal processing unit 62 functions as an image processing device including a synchronization circuit (a processing circuit which interpolates a spatial shift in a color signal associated with a color filter arrangement of a single plate CCD and converts the color signal into a simultaneous signal), a white balance adjustment circuit, a tone conversion processing circuit (for example, a gamma correction circuit), a contour correction circuit, a luminance/color difference signal generation circuit and the like, and performs predetermined signal processing with respect to R, G and B image signals stored in the SDRAM 26. In other words, the R, G and B image signals are converted into a YUV signal which consists of a luminance signal (Y signal) and color difference signals (Cr and Cb signals), and also applied with a predetermined process such as a tone conversion process (for example, gamma correction), in the digital signal processing unit 62. The image data processed by the digital signal processing unit 62 is stored in the VRAM 28.

If the taken image is outputted to the monitor 30, the image data is read from the VRAM 28 and transmitted to the display control unit 32 via the bus 20. The display control unit 32 converts the inputted image data into a video signal of a predetermined scheme for display and outputs the video signal to the monitor 30.

An AF detection unit 64 captures the image signals of the respective colors R, G and B captured from any one of image input controllers 60-1, 60-2, . . . , 60-N, and calculates a focus evaluation value required for AF control. The AF detection unit 64 includes a high pass filter which causes only a high frequency component of the G signal to pass through, an absolute value conversion processing unit, a focus area extraction unit which clips a signal within a predetermined focus area set on a screen, and an integration unit which integrates absolute value data within the focus area, and outputs the absolute value data within the focus area, which has been integrated by this integration unit, as the focus evaluation value to the CPU 12.

At the time of the AF control, the CPU 12 searches a position at which the focus evaluation value outputted from the AF detection unit 64 becomes local maximum, moves the focus lens 44 to the position and thereby focuses on a main subject. In other words, at the time of the AF control, the CPU 12 first moves the focus lens 44 from close range to infinity, and in the course of the moving, serially obtains the focus evaluation value from the AF detection unit 64, and detects the position at which the focus evaluation value becomes local maximum. Then, the CPU 12 determines that the detected position at which the focus evaluation value is local maximum is a focused position, and moves the focus lens 44 to the position. Thereby, the subject (main subject) located in the focus area is focused.

An AE/AWB detection unit 66 captures the image signals of the respective colors R, G and B captured from any one of the image input controllers 60-1, 60-2, 60-N, and calculates an integration value required for AE control and AWB control. In other words, the AE/AWB detection unit 66 divides one screen into multiple areas (for example, 8×8=64 areas) and calculates the integration value of the R, G and B signals for each divided area.

At the time of the AE control, the CPU 12 obtains the integration value of the R, G and B signals for each area, which has been calculated in the AE/AWB detection unit 66, obtains brightness (photometric value) of the subject, and performs exposure setting to obtain an appropriate exposure amount. In other words, the CPU 12 sets the image taking sensitivity, the aperture value, the shutter speed and whether or not strobe light emission is required.

Moreover, at the time of the AWB control, the CPU 12 inputs the integration value of the R, G and B signals for each area, which has been calculated by the AE/AWB detection unit 66, to the digital signal processing unit 62. The digital signal processing unit 62 calculates a gain value for white balance adjustment based on the integration value calculated by the AE/AWB detection unit 66. Moreover, the digital signal processing unit 62 detects a light source type based on the integration value calculated by the AE/AWB detection unit 66.

According to the instruction from the CPU 12, a compression/decompression processing unit 68 applies a compression process to the inputted image data to generate compressed image data of a predetermined format. For example, a compression process compliant with JPEG standard is applied to the still image, and a compression process compliant with MPEG2, MPEG4 or H.264 standard is applied to the moving image. Moreover, according to the instruction from the CPU 12, the compression/decompression processing unit 68 applies a decompression process to the inputted compressed image data to generate non-compressed image data.

The image file generation unit 70 generates a recorded image file (enhanced image file F100) for storing image data taken by the above described image taking units 10-1, 10-2, . . . , 10-N in the 3D mode (referred to as “image data P(1), P(2), . . . , P(N)”, respectively in the following description).

The enhanced image file F100 generated by the image file generation unit 70 is recorded on the memory card 74. According to the instruction from the CPU 12, a media control unit 72 controls reading/writing data with respect to the memory card 74.

An external connection interface unit (external connection I/F) 76 is a device which transmits and receives the data with respect to an external image processing apparatus (for example, a personal computer, a personal digital assistant, an image storage apparatus or a server). As a communication scheme with respect to the external image processing apparatus, for example, the USB, the IEEE 1394, the LAN, infrared data communication (IrDA) or the like is applicable.

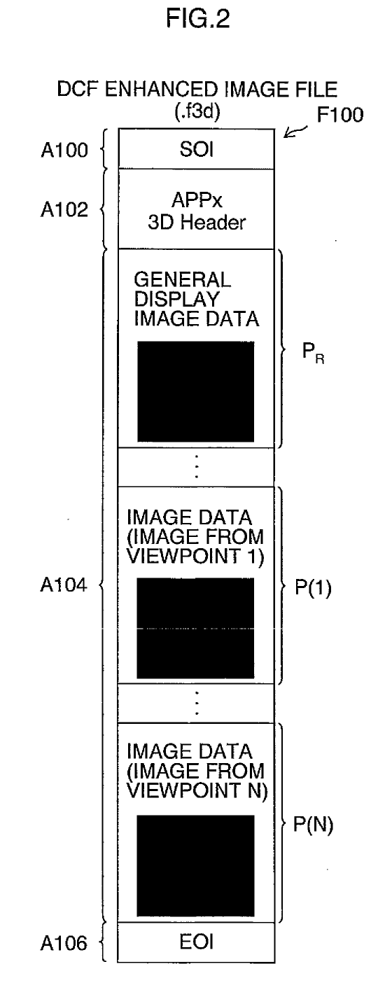

Next, the enhanced image file F100 will be described. FIG. 2 is a diagram schematically showing a data structure of the enhanced image file F100. As shown in FIG. 2, the enhanced image file F100 according to this embodiment includes a storage area A100 for a marker SOI (Start of Image) showing a start of data in the enhanced image file F100, a tag information storage area A102, an image data storage area A104, and a storage area A106 for a marker EOI (End of Image) showing an end of the data.

In the tag information storage area A102, 3D tag information in the enhanced image file F100 is stored. Here, the 3D tag information is information used for performing the three-dimensional display with a combination of two or more pieces of multi-viewpoint image data stored in the image data storage area A104, and for example, includes the number of viewpoints showing the number of pieces of the image data used for performing the three-dimensional display, information for specifying the image data used for performing the three-dimensional display, and pointer information which identifies a storage location (read start position) of each piece of the image data in the enhanced image file F100.

In the image data storage area A104, the image data P(1), P(2), . . . , P(N) taken by the above described image taking units 10-1, 10-2, . . . , 10-N are stored. Although an encoding format for the image data in the enhanced image file F100 is not particularly limited, the encoding format may be RAW data, Exif format, JPEG format, TIFF format, bitmap (BMP) format, GIF format or PNG format.

Furthermore, in the image data storage area A104, list display image data P_{R} used for performing list display is stored.

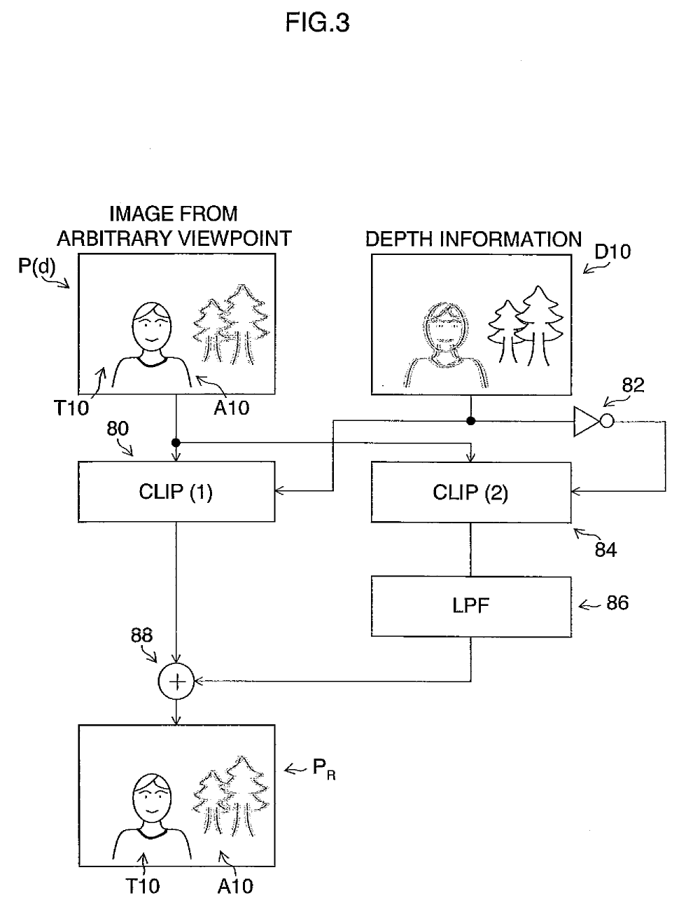

FIG. 3 is a diagram showing a processing flow in the image file generation unit 70 when the list display image data PR is generated. As shown in FIG. 3, image data P(d) from an arbitrary viewpoint d is selected from the image data P(1), P(2), . . . , P(N). Here, for example, the image data P(d) is selected by the image file generation unit 70 according to any method of the following [1] to [3].

[1] For example, in the case where the number of viewpoints is 2, the image data taken by the image taking unit corresponding to a dominant eye of a user (for example, the right eye by default, which can be set by the user) is selected.

[2] An image in which the viewpoint is located at a middle or adjacent to the middle (that is, an image taken by an image taking unit 10-d placed adjacent to the middle of the multiple viewpoints at the time of taking the parallax image) is selected as representative image data P(d). In other words, the representative image data P(d) becomes an image from a middle viewpoint in the case where the number of viewpoints N is an odd number, and becomes an image adjacent to the middle in the case where the number of viewpoints N is an even number. For example, if the number of viewpoints N=5, the representative image data becomes image data P(3) taken by an image taking unit 10-3, and if the number of viewpoints N=8, the representative image data becomes image data P(4) or P(5) taken by an image taking unit 10-4 or 10-5. Moreover, image data located adjacent to the middle of the image data storage area A104 in the enhanced image file F100 may be selected as the representative image data P(d).

[3] The image data on the side of the dominant eye of the user is selected as the representative image from the image data from the middle viewpoint and the image data adjacent to the middle.

It should be noted that the user may be able to specify the image data taken by a previously set image taking unit as the representative image data, or the user may be able to manually specify or change the representative image data.

Next, based on the depth information D10 provided by the subject distance information processing unit 54, an image of a main subject T10 (for example, a subject near the image taking apparatus 1 in the image) is clipped from the image data P(d) (80). Moreover, based on the depth information D10 inverted by an inverter 82, a background area A10 excluding the main subject T10 in the image data P(d) is clipped (84). Then, after a predetermined process has been applied to the background area A10 by a low pass filter (LPF) 86, the background area A10 is synthesized with the main subject T10 (88), and the list display image data P_{R} is generated. Here, as the process applied to the background area A10 in the LPF 86, for example, a process of deleting an image in the background area A10 is conceivable. Moreover, as another example, for example, at least one process of a process of blurring the background area A10, a process of desaturating the background area A10 (a process of diluting colors in the background area A10), and a process of reducing tone in the background area A10 (a process of decreasing contrast in the background area A10, which is, for example, a process of darkening the background area A10 or a process of brightening the background area A10) is conceivable.

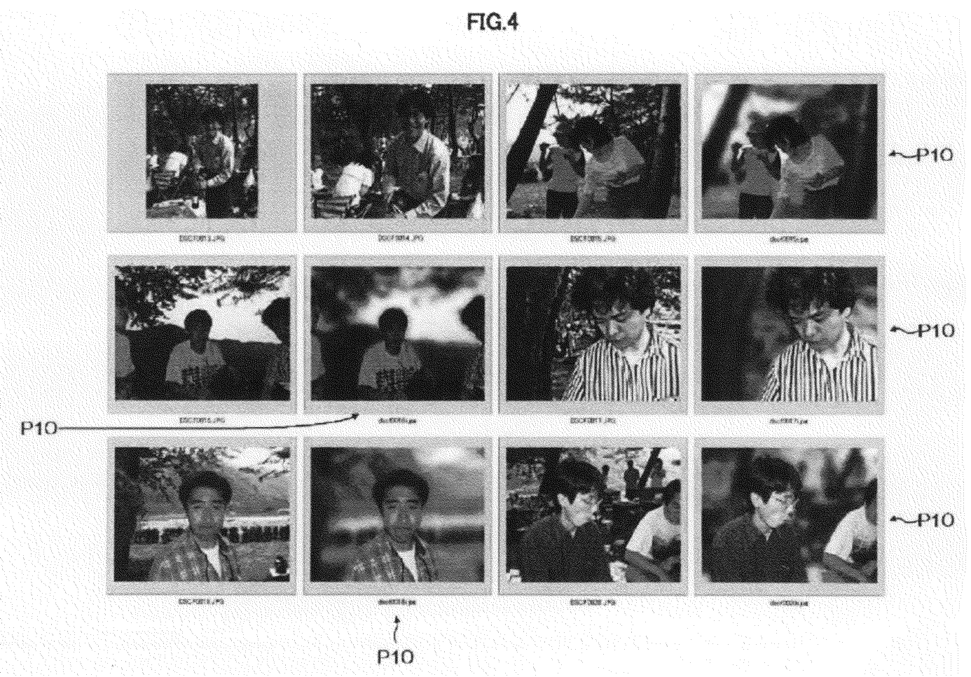

FIG. 4 is a diagram showing an example of the list display of the images. As shown in FIG. 4, according to this embodiment, when the images are displayed in a list it is possible to perform the list display in which an image file for the two-dimensional display and an image file for the three-dimensional display can be intuitively distinguished with less discomfort, by applying the predetermined process to the background area A10 to emphasize a stereoscopic effect and performing the display with respect to an image file P10 for the three-dimensional display, which has been taken in the 3D mode.

### Second Embodiment

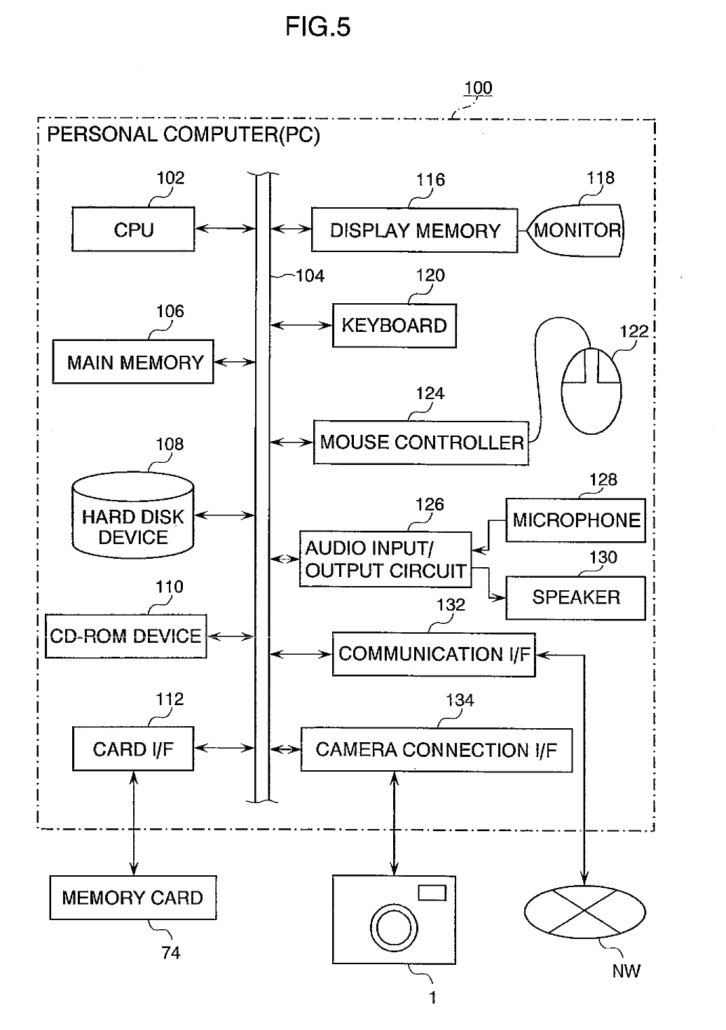

Next, a second embodiment of the present invention will be described. FIG. 5 is a block diagram showing a main configuration of an image processing apparatus according to a second embodiment of the present invention. In this embodiment, an image processing apparatus 100 is configured with, for example, a personal computer (PC), and is an apparatus which reads the recorded image file from the image taking apparatus or the memory card 74, stores and edits the recorded image file, and the like. As shown in FIG. 5, a central processing unit (CPU) 102 is connected to respective blocks within the image processing apparatus 100 via a bus 104, and controls operations of the respective blocks. A main memory 106 includes a storage area in which a control program is stored, or a work area used at program execution time. In a hard disk device 108, an operating system (OS) of the image processing apparatus 100, various application software, the recorded image files (a basic file F10 and the enhanced image file F100) read from the image taking apparatus 1 or the memory card 74, or the like is stored. A CD-ROM device 110 reads data from a CD-ROM disk (not shown). A card interface unit (card I/F) 112 reads the image data from the memory card 74. A display memory 116 temporarily stores display data. A monitor 118 is configured with, for example, a CRT (Cathode Ray Tube) monitor or a liquid crystal monitor, and displays the images, characters and the like based on the image data, character data and the like outputted from this display memory 116. A keyboard 120 and a mouse 122 accept an operational input from an operator, and input a signal depending on the operational input to the CPU 102. It should be noted that, in addition to the mouse 122, a touch panel, a touch pad or the like can be used as a pointing device. A mouse controller 124 detects a state of the mouse 122, and outputs a signal of a position of a mouse pointer on the monitor 118, the state of the mouse 122 or the like to the CPU 102. A microphone 128 and a speaker 130 are connected to an audio input/output circuit 126, various audio signals are inputted, and also various operational sounds are played and outputted depending on the operational input from the keyboard 120 and the like. A communication interface unit (communication I/F) 132 performs communication with a network NW. A camera connection interface unit (camera connection I/F) 134 transmits and receives data with respect to the image taking apparatus (an electronic camera, a digital camera) 1.

In the image processing apparatus 100 according to this embodiment, when the image for the two-dimensional display and the image for the three-dimensional display are obtained from the memory card 74 or the image taking apparatus 1 and displayed in the list, it is possible to perform the list display in which the image file for the two-dimensional display and the image file for the three-dimensional display can be intuitively distinguished with less discomfort, by generating the list display image data P_{R} in which the stereoscopic effect has been emphasized according to the above described process of FIG. 4 and storing the list display image data P_{R} in the enhanced image file F100, with respect to the image for the three-dimensional display.

It should be noted that the present invention can also be provided as, for example, a program applied to the image processing apparatus such as the image taking apparatus, the personal computer, the personal digital assistant, or the image storage apparatus. It should also be noted that the present invention can also be provided as a recording medium in which computer readable code of such program is stored.

What is claimed is:

1. An image display apparatus, comprising:
an image obtaining device which obtains image data taken from multiple viewpoints;
an image processing device which selects one of the image data and applies a process of emphasizing a stereoscopic effect with respect to the selected image data to generate list display image data;
a file generation device which generates a recorded image file which stores the list display image data and the image data taken from the multiple viewpoints; and
a display device which, when the recorded image file is displayed in a list, uses the list display image data to perform the list display.

2. The image display apparatus according to claim 1, wherein the image processing device applies a process of reducing an amount of visual information of a background area with respect to the selected image data to generate the list display image data.

3. The image display apparatus according to claim 2, wherein the image processing device applies at least one process of a process of deleting an image in the background area, a process of blurring the background area, a process of desaturating the background area, and a process of reducing tone in the background area, with respect to the selected image data to generate the list display image data.

4. The image display apparatus according to claim 1, wherein the image processing device selects image data taken by an image taking device in which the viewpoint is located adjacent to a middle, from the image data taken from the multiple viewpoints.

5. The image display apparatus according to claim 2, wherein the image processing device selects image data taken by an image taking device in which the viewpoint is located adjacent to a middle, from the image data taken from the multiple viewpoints.

6. The image display apparatus according to claim 3, wherein the image processing device selects image data taken by an image taking device in which the viewpoint is located adjacent to a middle, from the image data taken from the multiple viewpoints.

7. An image display method, comprising:
an image obtaining step of obtaining image data taken from multiple viewpoints;
an image processing step of selecting one of the image data and applying a process of emphasizing a stereoscopic effect with respect to the selected image data to generate list display image data;
a file generation step of generating a recorded image file which stores the list display image data and the image data taken from the multiple viewpoints; and
a display step of, when the recorded image file is displayed in a list, using the list display image data to perform the list display.

8. The image display method according to claim 7, wherein in the image processing step, a process of reducing a visual information amount of a background area is applied with respect to the selected image data, and the list display image data is generated.

9. The image display method according to claim 8, wherein in the image processing step, at least one process of a process of deleting an image in the background area, a process of blurring the background area, a process of desaturating the background area, and a process of reducing tone in the background area is applied with respect to the selected image data, and the list display image data is generated.
